(19) United States
(12) Patent Application Publication
(10) Pub. No.: US 2018/0029548 A1
(43) Pub. Date: Feb. 1, 2018

(54) PRE-ENTRY AUTO-ADJUSTMENT OF VEHICLE SETTINGS

(71) Applicant: Faraday&Future Inc., Gardena, CA (US)

(72) Inventors: Matthew Joseph COBURN, Redondo Beach, CA (US); Nicholas William DAZE, Los Angeles, CA (US)

(73) Assignee: Faraday&Future Inc., Gardena, CA (US)

(21) Appl. No.: 15/224,086

(22) Filed: Jul. 29, 2016

(51) Int. Cl. B60R 16/037

(52) U.S. Cl. CPC B60R 16/037

(57) ABSTRACT

A system for a vehicle at least one adjustable component of the vehicle is disclosed. They system may include a sensor configured to generate a signal indicative of an identity a user before the user enters the vehicle, and a controller in communication with the sensor and an actuator configured to adjust the at least one adjustable component. The controller may be configured to automatically cause the actuator to adjust the at least one adjustable component responsive to the signal.

### TECHNICAL FIELD

The present disclosure relates generally to adjustment of vehicle setting, and more particularly, to a pre-entry auto-adjustment of vehicle settings.

### BACKGROUND

Modern vehicles can be adjusted in many different ways to accommodate occupants of different sizes and preferences. For example, a seat can be raised or lowered, shifted forward or rearward, tilted fore or aft, lumbar-adjusted, and/or heated or cooled. In addition, a steering wheel can be moved in or out, and tilted up or down. Mirrors inside and outside of the vehicle can be tilted, shifted, and/or rotated. Displays can be moved, tilted, and/or have their appearances changed.

These adjustments can be power-assisted based on occupant input. For example, one or more actuators can be associated with the seat, the steering wheel, the mirrors, and/or the display, and selectively activated (e.g., via buttons, switches, and/or dials) to make the adjustments. In some instances, however, multiple different occupants may use a common vehicle. In these instances, each occupant may need to provide the inputs before the adjustments can be made and the vehicle can be driven in a comfortable manner Providing the input each time a user operates the vehicle can be cumbersome and time consuming. In addition, it may be difficult in some situations to make the right adjustments for each occupant.

Systems exist that identify occupants inside the vehicle and responsively make automated adjustments to the vehicle components. For example, a size and/or location of an occupant inside the vehicle may be detected (e.g., via a camera), and thereafter the adjustments may be made according to pre-established and/or recommended settings. Unfortunately, these adjustments are only made after the occupant is already inside the vehicle, which can make entry into the vehicle difficult and/or uncomfortable for some occupants. In addition, by waiting to make the adjustments until after the occupant is inside the vehicle, operation of the vehicle may be delayed by the time required for the adjustments to occur.

The disclosed vehicle system is directed to mitigating or overcoming one or more of the problems set forth above and/or other problems in the prior art.

### SUMMARY

One aspect of the present disclosure is directed to a system for adjusting at least one adjustable component of a vehicle. The system may include a sensor configured to generate a signal indicative of an identity of a user before entry of the user into the vehicle, and a controller in communication with the sensor and an actuator configured to adjust the at least one adjustable component. The controller may be configured to automatically cause the actuator to adjust the at least one adjustable component responsive to the signal.

Another aspect of the present disclosure is directed to a method of adjusting a component of a vehicle. The method may include detecting an identity of a user before the user enters the vehicle. The method may also include automatically causing an actuator to adjust the component responsive to the identity.

Yet another aspect of the present disclosure is directed to a vehicle. The vehicle may include at least one adjustable component, and an actuator configured to adjust the at least one adjustable component. The vehicle may also include a sensor mounted outside the body and configured to generate a signal indicative of an identity a user before the user enters the body, and a controller in communication with the actuator and the sensor. The controller may be configured to determine, based on the signal, that the identity of the user matches a known identity stored in memory, and to selectively recall a first set of adjustments corresponding to the known identity. The controller may also be configured to determine, based on the signal, biometrics of the user when the identity of the user does not match the known identity, and to determine a second set of adjustments to accommodate the biometrics of the user. The controller may be further configured to automatically cause the actuator to adjust the at least one adjustable component to achieve the first or second sets of adjustments.

### BRIEF DESCRIPTION OF THE DRAWINGS

FIG. 1 is a perspective illustration of an exemplary vehicle.

FIG. 2 is a diagrammatic illustration of an exemplary vehicle setting adjustment system that may be used with the vehicle of FIG. 1.

FIG. 3 is a flowchart illustrating an exemplary method that may be performed by the system of FIG. 2.

### DETAILED DESCRIPTION

The disclosure is generally directed to a system that adjusts user settings of a vehicle, before the user enters the vehicle. In particular, the disclosed system may be configured to identify the user as the user approaches the vehicle. When the identity of the user matches a known identity of a previous user, vehicle settings previously employed by the user may be selected for current use. In one embodiment, the identity of the user is determined based on image data captured by an external camera. In particular, captured image data may be compared to stored image data of previous users to determine if the user has previously used the vehicle. In another embodiment, the system may detect a personal device of the user, and identify the user as either a previous user or a new user via data stored on the personal device. When the system determines that the user is new (e.g., when the user has not yet used the vehicle), the image data may be employed to determine optimal settings for the new user (e.g., based on biometrics of the new user).

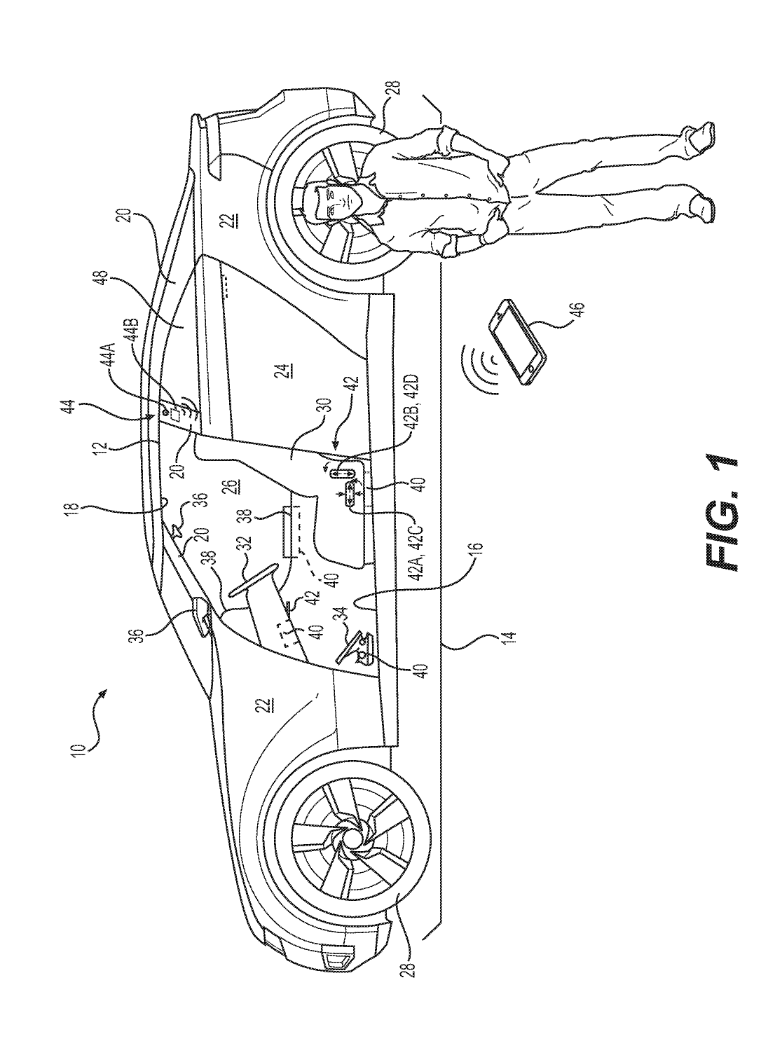

FIG. 1 is a perspective illustration of an exemplary vehicle 10. Although vehicle 10 is shown as a car in FIG. 1, it is contemplated that vehicle 10 may alternatively be a pickup truck, a utility vehicle, a van, or have any other body style. It is further contemplated that vehicle 10 may be an electric vehicle, a fuel-cell vehicle, a conventional combustion-powered vehicle, or a combination thereof. Vehicle 10 may be manually operated, remotely controlled, and/or autonomously operated.

Vehicle 10 may include a body 12 operatively connected to and supported by a rolling chassis 14. Body 12 may include a floor 16, a roof 18, and plurality of posts 20 that extend between floor 16 and roof 18. One or more body panels 22 and/or doors 24 may be connected between floor 16, roof 18, and/or posts 20 to at least partially enclose a user area 26 inside of body 12.

Any number of user-adjustable devices may be provided inside user area 26 of body 12 or external of body 12 for use in controlling different functions of vehicle 10 or providing information to the user. These devices may include, among other things, a seat 30, a steering wheel 32, one or more pedals (e.g., an accelerator pedal, a brake pedal, a clutch pedal, etc.) 34, one or more mirrors (e.g., a driver-side mirror, a passenger-side mirror, a rear-view mirror, etc.) 36, and one or more displays (e.g., a center-console display, an instrument cluster, a heads-up display, etc.) 38. Each of these components may be provided with an actuator 40, which can be selectively energized to cause a corresponding adjustment of the associated component. Actuator 40 may embody, for instance, an electric motor, a hydraulic cylinder, a pneumatic piston, a heater, a light source, or another device known in the art. For example, seat 30 may be raised, lowered, shifted, tilted, and/or otherwise adjusted when the corresponding actuator 40 is energized. Adjustments to steering wheel 32, pedal(s) 34, mirror(s) 36, and/or display(s) 38 may be achieved in similar manner

In some embodiments, the adjustments described above may be triggered based on user input. Specifically, one or more manually operated devices 42 may be associated with each of the user-adjustable components inside of user area 26 and, when manipulated, selectively energize the corresponding actuator 40. For example, seat 30 may be provided with a fore/aft switch 42a, a backrest tilt switch 42b, a height switch 42c, and/or a lumbar support switch 42d. Each of these devices 42 may be touched, pressed, pulled, twisted, or otherwise activated to generate corresponding signals that selectively energize particular actuators 40 of seat 30. Similar devices may be associated with each of steering wheel 32, pedal(s) 34, mirror(s) 36, and/or display(s) 38.

Vehicle 10 may include at least one sensor 44 configured to generate a signal indicative of an identity of a user before entry of the user into user area 26 (e.g., as the user approaches vehicle 10). In one example, sensor 44 is an optical sensor (e.g., a camera) 44a configured to generate image data associated with the user. In another example, sensor 44 is a radio receiver (e.g., a Blue Tooth receiver) 44b configured to retrieve (e.g., via a wireless network 45) identity data (e.g., a digital signature and/or certificate) stored on a personal device (e.g., an enabled cell phone, tablet, watch, or fob) 46 carried by the user. In some embodiments, vehicle 10 is equipped with both an optical sensor 44a and a radio receiver 44b. Sensor(s) 44 may be mounted externally (e.g., to one or more posts 20, body panels 22, and/or mirrors 36) or otherwise configured to obtain the image data and/or the identity data from the user before the user enters vehicle 10 (e.g., through a window 48).

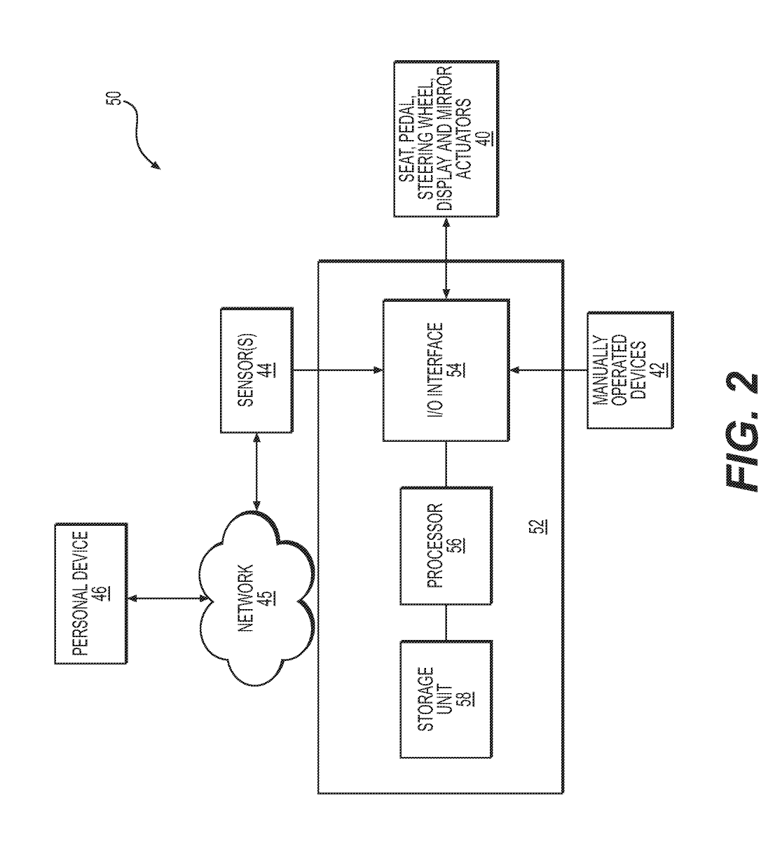

FIG. 2 diagrammatically illustrates an exemplary vehicle setting adjustment system 50, which can be used to automatically make some or all of the adjustments described above, regardless of manual input being received via devices 42. System 50 may include actuator(s) 40, manually operated device(s) 42, sensor(s) 44, network 45, personal device 46, and a controller 52 in communication with each of the other components. Controller 52 may comprise, among other things, an I/O interface 54, a processor 56, and a storage unit 58. One or more of the components of controller 52 may be included in an on-board computer of vehicle 10, a remote server, or in the cloud. The components of system 50 may be configured to transfer data and send or receive instructions between each other.

I/O interface 54 may be configured for two-way communication between controller 52 and the various remaining components of system 50, such as actuator(s) 40, device(s) 42, sensor(s) 44, and personal device 46. The communication may be facilitated via cables, network 45, or other communication mediums.

Processor 56 may include any appropriate type of general-purpose or special-purpose microprocessor, digital signal processor, or microcontroller. Processor 56 may be configured with virtual processing technologies, and use program logic to simultaneously execute and control any number of operations. For example, processor 56 may be configured to receive and process signals to determine appropriate adjustments that should be made to the user-adjustable components of vehicle 10 based on a determined identity and/or measured biometrics of a user of vehicle 10. Processor 56 may also be configured to implement virtual machine or other known technologies to execute, control, run, manipulate, and store any number of software modules, applications, programs, etc. For example, processor 56 may be configured to generate and transmit command signals, via I/O interface 54, in order to energize actuators 40.

Storage unit 58 may include a volatile or non-volatile, magnetic, semiconductor, tape, optical, removable, non-removable, or other type of tangible and/or non-transitory computer-readable medium that stores one or more computer programs and data. The computer programs may be executable by controller 52 to perform specialized functions of system 50. For example, storage unit 58 may be configured to store software for biometric detection of users, such as body scanning, facial recognition, iris scanning, and/or voice recognition. In addition, sensor(s) 44 may benefit from the use of image and video processing software, (e.g., image recognition software), which can be stored within storage unit 58. Using this software, sensor(s) 44 may be employed by controller 52 to distinguish a person from inanimate objects, and to distinguish identities, facial features, and/or other biometric aspects of users. Storage unit 58 may also be configured to store profiles of previous users of vehicle 10, such as names, digital signatures, certificates of authorization, settings of adjustable components, user biometrics, and other information. In some embodiments, after being paired a first time with personal device 46, processor 56 (e.g., using software recalled from storage unit 58) may be configured to thereafter recognize personal device 46 based on corresponding data (the digital signature and/or authorization certificate emitted by personal device 46) recorded into storage unit 58 during pairing.

The computer programs may also include operating systems (not shown) that perform known functions when executed by processor 56. By way of example, the operating systems may include Microsoft Windows™, Unix™, Linux™, iOS™ operating systems, Android™ operating systems, such as Microsoft CE™, or other types of operating systems. Storage unit 58 may also include communication software that, when executed by processor 56, facilitates communications via network 45, such as Web browser software, tablet software, and/or smart handheld device networking software, etc.

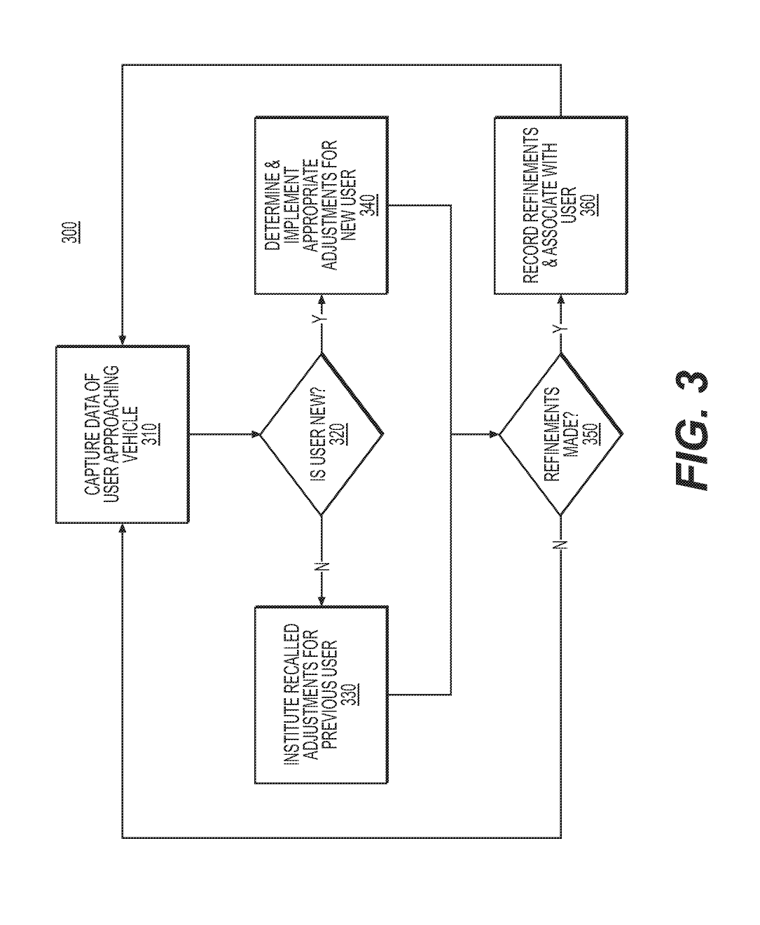

An exemplary method of operation 300 that can be implemented by system 50 is illustrated in the flowchart of FIG. 3. As shown in this figure, method 300 may begin with the capturing of user data before the user enters vehicle 10 (e.g., as the user approaches vehicle 10) (Step 310).

The data-capturing step 310 may be performed in several different ways. For example, as the user moves into range of sensor 44a, image data associated with the user may be captured and transmitted as signals to processor 56 via I/O interface 54. Responsive to the signals from sensor 44a, processor 56 may compare the captured image data to stored image data associated with previous users of vehicle 10 to determine if the user is a new user (Step 320). When the captured image data substantially matches (e.g., matches within a threshold amount) the stored image data of a particular previous user (step 320: N), processor 56 may conclude that the user has previously operated vehicle 10. Otherwise, processor 56 may conclude that the user is a new user (step 320: Y). In another example, as the user moves into range of sensor 44b, a digital signature and/or certificate of authorization associated with the user may be received from personal device 46 (e.g., via network 45) and transmitted as signals to processor 56 via I/O interface 54. Responsive to the signals from sensor 44b, processor 56 may compare the digital signature and/or certificate of authorization to stored data associated with previous users of vehicle 10 to determine if the user is new or has previously operated vehicle 10. When the retrieved signature and/or certificate substantially matches (e.g., matches within a threshold amount) the stored signature and/or certificate of a particular previous user (step 320: N), processor 56 may conclude that the user has previously operated vehicle 10. Otherwise, processor 56 may conclude that the user is a new user (step 320: Y).

When the user approaching vehicle 10 is determined to have previously operated vehicle 10, processor 56 may recall from storage unit 58 and institute (e.g., via corresponding commands directed to actuator(s) 40) a set of adjustments for one or more of the user-adjustable components that were previously made by the user or previously determined by controller 52 (Step 330). In this manner, the user-adjustable components may be caused to return to particular configurations that were previously found by the user to be convenient and/or comfortable.

However, when the user approaching vehicle 10 is determined to be new (e.g., to not have operated vehicle 10 before or within a threshold period of time), processor 56 may determine and implement (e.g., via corresponding commands directed to actuator(s) 40) a set of adjustments for one or more of the user-adjustable components that should be appropriate for the new user (Step 340). This determination may be made, for example, based on reference to biometric information contained in the captured image data of stored biometric information and corresponding adjustments. In particular, from the captured image of the data, particular biometric information (e.g., overall height, torso length, leg length, arm reach, build, weight, gender, etc.) may be gleaned using corresponding biometric software. One or more parts of this information may then be compared to a table stored in memory to determine corresponding adjustments. For example, for a particular leg length, a fore/aft adjustment of seat 30 may be determined by processor 56, and corresponding commands may be directed to associated actuator(s) 40. Similarly, for a particular torso height, a height adjustment of seat 30 may be determined and commanded. Likewise, for a particular arm length, a tilt of seat 30 and/or a position or angle of steering wheel 32 may be determined and commanded. Other adjustments may be determined and then commanded in this same manner using the biometric information of the user.

After completion of step 330 or step 340, controller 52 may monitor input devices 42 to determine if the user makes any refinements to the adjustments (Step 350). In particular, it may be possible for the user to manipulate one or more of input devices 42 after controller 52 has adjusted the user-adjustable components in order to increase a convenience and/or comfort in accessing the user-adjustable components. In these instances, controller 52 may record the refinements in association with the identity of the user (Step 360), such that future adjustments made for the same user may include the refinements. Method 300 may then return from step 360 to step 310 for repetition of method 300. If refinements are not made after automated adjustment of the user-adjustable components (step 350: N), control may proceed from step 350 to step 310. Additionally, controller may utilize refinements to the adjustments (Step 350) to optimize default settings for new users who have similar biometric data to the user who made the refinements to the adjustments.

It will be apparent to those skilled in the art that various modifications and variations can be made to the disclosed system, related method, and vehicle. Other embodiments will be apparent to those skilled in the art from consideration of the specification and practice of the disclosed system, related method, and vehicle. For example, in some cases, controller 52 may determine whether the user has operated another vehicle associated with the same network 45 as vehicle 10, and responsively load adjustments for the user based on the user's adjustments in the other vehicle.

It is intended that the specification and examples be considered as exemplary only, with a true scope being indicated by the following claims and their equivalents.

What is claimed is:

1. A system for adjusting at least one adjustable component of a vehicle,
including:
a sensor configured to generate a signal indicative of an identity of a user before the user enters the vehicle; and
a controller in communication with the sensor and an actuator configured to adjust the at least one adjustable component, the controller being configured to automatically cause the actuator to adjust the at least one adjustable component responsive to the signal.

2. The system of claim 1, wherein the at least one adjustable component includes at least one of a seat, a steering wheel, a pedal, a mirror, and a display.

3. The system of claim 1, wherein the sensor is a camera configured to capture an image of the user.

4. The system of claim 1, wherein the sensor is a wireless receiver configured to communicate with a personal device carried by the user.

5. The system of claim 1, wherein the controller is further configured to:
determine, based on the signal, that the identity of the user matches a known identity stored in memory;
selectively recall a first set of adjustments corresponding to the known identity; and
automatically cause the actuator to adjust the at least one adjustable component according to the first set of adjustments.

6. The system of claim 1, wherein the controller is further configured to:
determine, based on the signal, that the identity of the user does not match a known identity;
determine biometrics of the user;
determine a second set of adjustments to accommodate the biometrics of the user; and
automatically cause the actuator to adjust the at least one adjustable component according to the second set of adjustments.

7. The system of claim 6, further including at least one input device movable by the user to make a refinement to the second sets of adjustments after the user enters the vehicle.

8. The system of claim 7, wherein the controller is further configured to save the refinement in connection with the identity of the user.

9. The system of claim 1, wherein the sensor is mountable external to the vehicle.

10. A method of adjusting a component of a vehicle, including:
detecting an identity of a user before the user enters the vehicle; and
automatically causing an actuator to adjust the component responsive to the identity.

11. The method of claim 10, wherein the at least one adjustable component includes at least one of a seat, a steering wheel, a pedal, a mirror, and a display.

12. The method of claim 10, wherein detecting the identity of the user includes:
capturing image data associated with the user; and
comparing the image data to image data of known users stored in memory.

13. The method of claim 10, wherein detecting the identity of the user includes:
wirelessly communicating with a personal device carried by the user; and
referencing data from the personal device with data from personal devices carried by known users.

14. The method of claim 10, wherein:
the method further includes:
determining that the identity of the user matches a known identity stored in memory; and
selectively recalling a first set of adjustments corresponding to the known identity; and
automatically causing the actuator to adjust the component includes automatically causing the actuator to adjust the component to achieve the first set of adjustments.

15. The method of claim 14, further including:
determining that the identity of the user does not match the known identity;
determining biometrics of the user;
determining a second set of adjustments to accommodate the biometrics of the user; and
automatically causing the actuator to adjust the component to achieve the second set of adjustments.

16. The method of claim 15, further including:
receiving input from the user indicative of a refinement to the first or second sets of adjustments after entry of the user into the vehicle; and
causing the actuator to adjust the component to achieve the refinement.

17. The method of claim 16, further including recording the refinement into memory in connection with the identity of the user.

18. A vehicle, including:
at least one adjustable component;
an actuator configured to adjust the at least one adjustable component;
a sensor mounted outside the body and configured to generate a signal indicative of an identity a user before entry of the user into the body; and
a controller in communication with the actuator and the sensor, the controller being configured to:
determine, based on the signal, that the identity of the user matches a known identity stored in memory;
selectively recall a first set of adjustments corresponding to the known identity;
determine, based on the signal, biometrics of the user when the identity of the user does not match the known identity;
determine a second set of adjustments to accommodate the biometrics of the user; and
automatically cause the actuator to adjust the at least one adjustable component to achieve the first or second sets of adjustments.

19. The vehicle of claim 18, wherein the at least one adjustable component includes at least one of a seat, a steering wheel, a pedal, a mirror, and a display.

20. The vehicle of claim 18, wherein the sensor is one of a camera configured to capture an image of the user, and a wireless receiver configured to communicate with a personal device carried by the user.
